(19) United States
(12) Patent Application Publication
(10) Pub. No.: US 2018/0183299 A1
(43) Pub. Date: Jun. 28, 2018

(54) ORC & S-CO2 BRAYTON CYCLE FUEL CELL(S) UTILITY PATENT WITH PROCESS CLAIMS

(71) Applicant: ROBERT CHRISTOPHER STEVENS, SILVER SPRING, MD (US)

(72) Inventor: ROBERT CHRISTOPHER STEVENS, SILVER SPRING, MD (US)

(21) Appl. No.: 15/388,686

(22) Filed: Dec. 22, 2016

(51) Int. Cl. H02K 7/18; B60L 11/04

(52) U.S. Cl. CPC H02K 7/1823; F03B 17/005; Y10S 415/916; B60L 11/04

(57) ABSTRACT

Particular order, sequence and arrangement coupling ORC and S—CO2 Brayton Cycle Fuel Cells to Infinity Turbine's “ROT” mini turbine to electric generator producing electricity. Sequence, order and arrangement referred to as the “package.” ORC and S—CO2 Brayton Cycle Fuel Cells size reduction from plant size CHP to less than 3.5 cubic feet of the “package” and installing “package” into existing EVs—electric vehicles, transform former EVs into PPP EVs—Portable Power Plant Electric Vehicles thus “dispersed autonomous energy.

### SUMMARY OF THE INVENTION

Heretofore the Organic Rankine Cycle Industrial plant size “CHP” Combine Heat and Power utilized working fluids of water and Freon to gather and exchange BTUs. Expanding Freon drive large turbine(s) coupled to generator(s) thus producing electricity. This invention reduces size from plant size CHP to total required area/volume of 3.5 cubic feet inclusive of ORC and S—CO2 Fuel Cells coupled to Infinity Turbine's “ROT” mini turbine coupled to generator. The particular arrangement, sequence and process is known as the “package.” When the “package” is dropped into any/all existing electric vehicle(s), said vehicle transforms into a “Portable Power Plant” (commonly referred to as “dispersed autonomous energy”) EV, thus eliminating and displacing lithium and all rechargeable batteries in former electric vehicle(s).

Applied to all transportation applications, Portable Power Plant Electric Vehicles or “PPP EVs,” range from former EVs (Electric Vehicles) to any electric motor powered and propelled vehicle such as boats, planes, ultra lights (planes)—in short any electric motor powered vehicle—and are transformed into PPP EVs/Portable Power Plant Electric Vehicles. When not in transportation mode and use, PPP EVs plug into the national grid thus supplying green, renewable and sustainable electricity to said grid. PPP EVs utilize existing footprint of former EVs.

### BACKGROUND OF THE INVENTION

Heretofore waste heat collected on an industrial plant size level process known as “CHP” Combined Heat and Power utilizing 125 degrees Fahrenheit or Organic Rankine Cycle, pumped working fluid (water) into a heat exchanger transferring BTUs from working fluid of water to working fluid of Freon. Expanding Freon drives large turbine(s) coupled to generator(s) thus producing electricity. Expended Freon condenses then recycles in a closed loop. Footprint of above described CHP Process/Method system is conventional plant size. This invention, ORC and S—CO2 fuel cells, reduces size/volume requirement from industrial or factory size to less than 3.5 cubic feet.

Process inserts Infinity Turbine's “ROT” mini turbine coupled to a generator thus producing electricity. Infinity Turbine's “ROT” (Radial Operated Turbine) spins at low rpm matching generator's low rpm eliminating the former need of “gear/spin reduction box.” The particular, sequence and arrangement of the ORC and S—CO2 Fuel Cells coupled to Infinity Turbine's ROT mini turbine in turn coupled to a generator, is referred to as the “package.” When the “package” is dropped into all electric vehicles powered and propelled by electric motors, it transforms said vehicles into a “Portable Power Plant Electric Vehicle” (PPP EV) thus what is referred to as “dispersed autonomous power.”

### DETAILED DESCRIPTION OF THE INVENTION

Heretofore waste heat collected on an industrial plant size level process known as “CHP” Combined Heat and Power utilizing 125 degrees Fahrenheit or Organic Rankine Cycle, circulated and pumped working fluid (water) gathered plant wide into a heat exchanger transferring BTUs from working fluid water to working fluid Freon. Expanding Freon drives large turbine(s) coupled to generator(s) producing electricity. Expended Freon condenses then recycles in a closed loop. Footprint of above described CHP Process/Method system is conventional plant size.

This invention, ORC and S—CO2 fuel cells, reduces footprint, size and volume requirement from Industrial or factory size to less than 3.5 cubic feet furthermore, eliminates multiple working fluids specifically water gathering waste heat, relying solely upon Freon ORC and S—CO2 Brayton Cycle working fluids. Ambient air and air temperature replace former working fluid—water, exchanging and transferring BTUs via coils eliminating and displacing former need of both working fluid water and circulation throughout Industrial size plant.

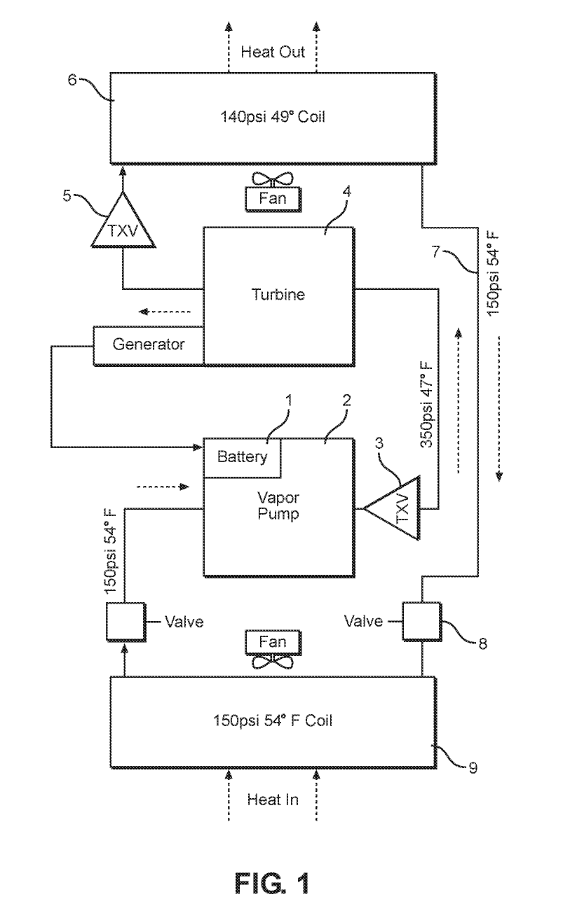

FIG. 1 illustrates ORC Fuel Cell operation using R410 as example representing all Freon types. “Number 1” is battery used for initiating and starting ORC Fuel Cell operation activating vapor pump “Number 2.” R410 enters vapor pump “Number 2” at a temperature of 54 degrees Fahrenheit and pressure of 150 psi. “Number 2” vapor pump increases pressure from 150 psi to 350 psi before TXV “Number 3.” R410 enters and exists “Number 3” TXV @ 350 psi and 47 degrees Fahrenheit. R410 enters “Number 4” Infinity Turbine's “ROT” mini turbine coupled to generator @ 350 psi and 47 degrees Fahrenheit.

R410 exits “Number 4” Infinity Turbine's “ROT” mini turbine coupled to a generator @ 140 psi and 49 degrees Fahrenheit entering and exiting “Number 5” TXV @ 140 psi and 49 degrees Fahrenheit. R410 enters coil “Number 6” @ 140 psi and 49 degrees Fahrenheit. R410 exits coil “Number 7” @ 150 psi and 54 degrees Fahrenheit. R410 enters Schrader valve “Number 8” at 150 psi and 54 degrees Fahrenheit. R410 enters and exists coil “Number 9” @ 150 psi and 54 degrees Fahrenheit returning to vapor pump “Number 2.”

Process consisting specific order, sequence and arrangement of ORC and S—CO2 Fuel Cells coupled to Infinity Turbine's “ROT” mini turbine coupled to a generator, referred to as “the package,” produces electricity. Infinity Turbine's “ROT” (Radial Operated Turbine) spins at low rpm matching generator's low rpm eliminating former need of “gear/spin reduction box.” Process of the particular order, sequence and arrangement of the ORC and S—CO2 Fuel Cells coupled to Infinity Turbine's ROT mini turbine in turn coupled to a generator, is referred to as the “package.” When dropped into all and any existing or newly manufactured electric vehicle(s), “package” transforms said vehicle(s) into “Portable Power Plant Electric Vehicles” (PPP EVs) eliminating all rechargeable and all lithium batteries, powering both EVs' electric motor and supplying remaining surplus electricity to the grid. PPP EV PORTABLE Power Plant Electric vehicles provide “dispersed autonomous power.”

Applied to all transportation applications using electric motors, Portable Power Plant Electric Vehicles or “PPP EVs,” include former EVs (Electric Vehicles) and all electric motor powered and propelled vehicle such as boats, planes, ultra lights (planes)—in short any electric motor powered and propelled vehicle. Upon “package” installation and insertion into former and newly manufactured EVs electric vehicles, package discards and displaces all existing lithium and all rechargeable batteries transforming pre “package” (“package” consisting of ORC and S—CO2 Fuel Cells coupled to Infinity Turbine's “ROT” mini turbine coupled to Generator) EVs into PPP EVs/Portable Power Plant Electric Vehicles. When not in transportation use, PPP EVs plug into the national grid supplying green sustainable electricity to said grid. PPP EVs utilize existing footprint of former EVs. Use of CO2 as a working fluid permanently isolates, contains and encapsulates CO2 removing it from the environment.

### BRIEF DESCRIPTION OF DRAWINGS

1. Battery activates vapor pump. Incoming R410 @ 150 psi 54 degrees F.

2. Vapor pump increases psi from 150 psi 54 degrees F. to 350 psi 47 degrees F. before TXV

3. R410 leaves TXV @ 350 psi 47 degrees F.

4. R410 enters Infinity Turbine's “ROT” mini turbine @ 350 psi 47 degrees F.

5. R410 enters TXV @ 140 psi 49 degrees F.

6. R410 enters coil @ 140 psi 49 degrees F.

7. R410 leaves coil @ 150 psi 54 degrees F.

8. R410 enters Schrader valve @ 150 psi 54 degrees F.

9. R410 enters and exists coil @ 150 psi 54 degrees F. returns to vapor pump

Ambient air temperature exchanges BTUs, input to system converting R410 states to high pressure thus driving turbine coupled to generator outputting electricity.

Brayton Cycle pressure and temperature values are different—above description utilizes R410 as working fluid illustrating all Freon types.

Method or process of inserting Infinity Turbine's ROT mini turbine coupled to generator into “ORC Fuel Cell” and “Brayton Cycle Fuel” produces electricity.

1. Process of ORC Fuel Cell coupled to a radial operated mini turbine “ROT” mini turbine coupled to generator, referred to as “the package,” produces electricity providing electric power both for surplus to grid supply and electric motor(s) of all EVs electric vehicles displacing and eliminating lithium and all rechargeable batteries.

2. Process of S—CO2 Brayton Cycle Fuel Cell coupled to a radial operated mini turbine S—CO2 “ROT” mini turbine coupled to electric generator, referred to as “the package,” produces electricity providing electric power both for surplus to grid supply and electric motor(s) of all EVs electric vehicles displacing and eliminating lithium and all rechargeable batteries.

3. Process of particular arrangement, order and sequence of ORC and S—CO2 Brayton Cycle Fuel Cells coupled to a radial operated mini turbine“ROT” mini turbine and S—CO2 “ROT” mini turbine coupled to electric generator, referred to as “the package,” produces electricity providing electric power both for surplus to grid supply and electric motor(s) of all EVs electric vehicles displacing and eliminating lithium and all rechargeable batteries.

4. Process of installing into all existing and newly manufactured electric vehicles EVs ORC and S—CO2 Fuel Cells coupled to “ROT” mini turbine and S—CO2 “ROT” mini turbine coupled to electric generator, referred to as “the package,” produces electricity providing electric power both for surplus to grid supply and electric motor(s) of all EV electric vehicles displacing and eliminating lithium and all rechargeable batteries, creates and transforms all ordinary electric vehicles EVs into Portable Power Plant Electric Vehicle(s) PPP EVs providing dispersed autonomous energy.
